(19) United States
(12) Patent Application Publication
(10) Pub. No.: US 2023/0368034 A1
(43) Pub. Date: Nov. 16, 2023

(54) LEARNING APPARATUS, LEARNING METHOD AND PROGRAM

(71) Applicant: NIPPON TELEGRAPH AND TELEPHONE CORPORATION, Tokyo (JP)

(72) Inventors: Kazuo AOYAMA, Tokyo (JP); Hiroshi SAWADA, Tokyo (JP)

(21) Appl. No.: 18/250,254

(22) PCT Filed: Dec. 8, 2020
(86) PCT No.: PCT/JP2020/045699

§ 371 Date: Apr. 24, 2023

(51) Int. Cl. G06N 3/084

(52) U.S. Cl. CPC G06N 3/084

(57) ABSTRACT

A learning apparatus according to an embodiment is a learning apparatus that learns a neural network including a linear transformation layer achieved by a weight matrix with a complex number as an element, the learning apparatus including: a formulating unit that formulates a differential equation of a loss function with respect to each of conjugate variables corresponding to input variables of the linear transformation layer and a differential equation of the loss function with respect to each of parameters of the neural network; and a learning unit that learns the parameters of the neural network by backpropagation using the differential equations formulated by the formulating unit.

### TECHNICAL FIELD

The present invention relates to a learning apparatus, a learning method, and a program.

### BACKGROUND ART

In the fields of artificial intelligence, machine learning, and the like, models called neural networks (NNs) have been widely used and, recently, a neural network using a unitary matrix as a weight matrix has been attracting attention. A unitary matrix refers to a matrix W that has a complex number as an element and that satisfies WW^{†} = I, where W^{†} represents a conjugate transpose matrix of W and I represents an identity matrix. A neural network including a weight matrix having complex numbers as elements is also called a “complex neural network”.

The following two reasons are mainly considered as reasons why a neural network using a unitary matrix as a weight matrix has been attracting attention.

The first reason is that there have been reports on the effectiveness of a method using a unitary matrix as a weight matrix in order to mitigate a “vanishing or exploding gradient problem” that may occur when learning a deep neural network (DNN: Deep NN). In particular, because backpropagation, which is normally used in learning of a DNN, utilizes a gradient, using a unitary matrix is effective in terms of the learning efficiency.

The second reason is that, in an implementation of an optical neural network (Optical NN, Photonic NN), a matrix-vector multiplication part includes a Mach-Zehnder interferometer (MZI), which is an implementation of a Givens rotation matrix (Non-Patent Literature 1).

In this case, methods of restricting a weight matrix to a unitary matrix can be roughly classified into two methods.

The first method is a method of imposing a constraint when optimizing a weight matrix. In this method, after optimizing the weight matrix so as to satisfy the constraint, projection or retraction is required to obtain a strict unitary matrix. Therefore, it is difficult to obtain a strict unitary matrix in a state where accuracies of learning and inference of a neural network are maintained. The method also makes learning difficult because, while an arbitrary unitary matrix can be constructed, further constraints are required to construct a specific unitary matrix.

The second method is a method of using a unitary matrix as a fundamental matrix to construct an arbitrary unitary matrix with a product of a plurality of unitary matrices and a diagonal matrix (Non-Patent Literature 2). This method uses a property that a product of unitary matrices is a unitary matrix and always enables a strict unitary matrix to be constructed. In addition, a specific unitary matrix can also be constructed by changing the composition of a matrix product. Hereinafter, a weight matrix constructed by this method will also be referred to as a “structurally-constrained weight matrix”.

When an arbitrary unitary matrix is constructed by the second method described above, a Givens rotation matrix may also be used as a fundamental matrix. A method of constructing an arbitrary unitary matrix using a Givens rotation matrix as a fundamental matrix is known (Non Patent Literature 3) and is referred to as Clements’ method or the like.

### CITATION LIST

### Non-Patent Literature

[Non-Patent Literature 1] Yichen Shen, et al. “Deep learning with coherent nanophotonic circuits,” Nature Photonics, vol. 11, pp 441-446, 2017.
[Non-Patent Literature 2] Li Jing, et al. “Tunable efficient unitary neural networks (EUNN) and their applications to RNNs,” Proc. Int. Conf. Machine Learning (ICML), 2017.
[Non-Patent Literature 3] W.R. Clements, P.C. Humphreys, B.J. Metcalf, W.S. Kolthammer, and I.A. Walmsley, “Optimal design for universal multiport interferometers,” Optica, vol. 3, No. 12, pp. 1460, 2016.

### SUMMARY OF INVENTION

### Technical Problem

However, when learning a neural network using a unitary matrix constructed by Clements’ method as a weight matrix by automatic differentiation, a computational graph becomes a deep graph including a large number of nodes and a large amount of calculation is required during backpropagation. As a result, learning the neural network also takes much time.

An embodiment of the present invention has been made in view of the foregoing and an object thereof is to efficiently learn a neural network including a structurally-constrained weight matrix.

### Solution to Problem

In order to achieve the object described above, a learning apparatus according to an embodiment is a learning apparatus that learns a neural network including a linear transformation layer achieved by a weight matrix with a complex number as an element, the learning apparatus including: a formulating unit configured to formulate a differential equation of a loss function with respect to each of conjugate variables corresponding to input variables of the linear transformation layer and a differential equation of the loss function with respect to each of parameters of the neural network; and a learning unit configured to learn parameters of the neural network by backpropagation using the differential equations formulated by the formulating unit.

### ADVANTAGEOUS EFFECTS OF INVENTION

A neural network including a structurally-constrained weight matrix can be learned in an efficient manner.

### BRIEF DESCRIPTION OF DRAWINGS

FIG. 1 is a diagram for describing an example of a Givens rotation matrix.

FIG. 2 is a diagram for describing an example of an MZI symbol.

FIG. 3 is a diagram for describing an example of a linear transformation layer implemented with a Givens rotation matrix product.

FIG. 4 is a diagram for describing an example of Forward and Backward calculations.

FIG. 5 is a diagram illustrating an example of a hardware configuration of a learning apparatus according to an embodiment.

FIG. 6 is a diagram illustrating an example of a functional configuration of the learning apparatus according to the embodiment.

FIG. 7 is a diagram illustrating an example of a neural network including a linear transformation layer implemented with a Givens rotation matrix product.

FIG. 8 is a diagram for explaining experiment results.

FIG. 9 is a diagram for describing an example of a linear transformation layer implemented with a Fang-type matrix.

FIG. 10 is a diagram for describing an example of linear transformation layers implemented with a matrix decomposition of a Fang-type matrix.

### DESCRIPTION OF EMBODIMENTS

Hereinafter, embodiments of the present invention will be described.

### First Embodiment

In the present embodiment, a learning apparatus 10 that can efficiently learn a neural network (NN) including a structurally-constrained weight matrix will be described. In particular, a case will be described in which a Givens rotation matrix is assumed as a fundamental matrix and a neural network including an arbitrary unitary matrix formed by a product of a plurality of Givens rotation matrices and a diagonal matrix as a weight matrix is learned in an efficient manner.

### <Theoretical Configuration>

Hereinafter, a theoretical configuration of the present embodiment will be described.

### <<Givens Rotation Matrix>>

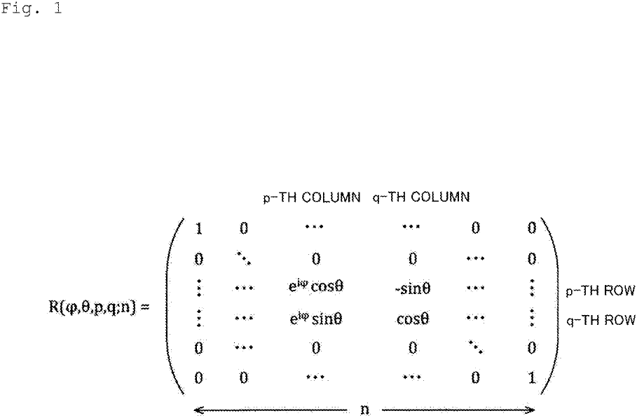

FIG. 1 illustrates n rows and n columns (hereinafter, also expressed as “n×n”, where n is an integer of 1 or greater) Givens rotation matrix. A Givens rotation matrix according to the present specification is also generally referred to as a complex Givens rotation matrix.

As illustrated in FIG. 1, the Givens rotation matrix is a sparse unitary matrix with effective elements (in other words, elements handled as variables with parameters θ, φ) at (p, p), (p, q), (q, p), and (q, q) (where p < q). Hereinafter, this Givens rotation matrix will be expressed as R (φ, θ, p, q; n) or simply R. A Givens rotation matrix formed by only the variables is a 2×2 matrix.

Generally, while two matrices are non-commutative with respect to multiplication, in the case of Givens rotation matrices, two Givens rotation matrices including different p and q are commutative. In other words, let R denote a Givens rotation matrix including p and q and R′ denote a Givens rotation matrix including p′ and q′, where p ≠ p′ and q ≠ q′. In this case, RR′ = R′R. Hereinafter, a matrix represented by a product of a plurality of such commutative Givens rotation matrices will also be referred to as a Givens rotation matrix as long as confusion is avoided.

### <<MZI Symbol>>

For the following description, a symbol of the Mach-Zehnder interferometer (MZI) will be prepared. The MZI symbol is also used in Non Patent Literature 2 described above and represents a product of a Givens rotation matrix and a vector. For example, when X = [x₁, ..., xₙ]^{t} and Y = [yᵢ, ..., yₙ]^{t} are n-dimensional vectors and R denotes an n×n Givens rotation matrix, then Y = RX can be represented by an MZI symbol. Note that t is a symbol that represents transposition.

Specifically, when n = 2, Y = RX is

[Math. 1]

$$\left(\begin{matrix}{y}_{1} \\ {y}_{2}\end{matrix}\right) = \left(\begin{matrix}{e}^{i φ} cos θ & - sin θ \\ {e}^{i φ} sin θ & cos θ\end{matrix}\right) \left(\begin{matrix}{x}_{1} \\ {x}_{2}\end{matrix}\right)$$

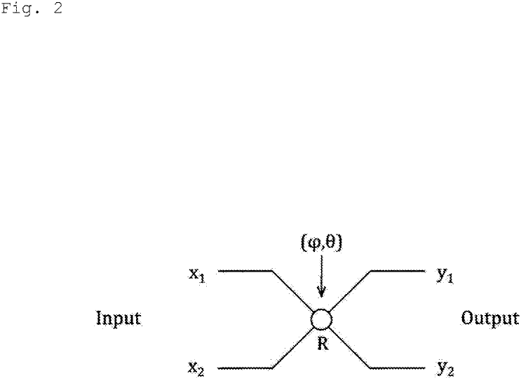

which can be represented by an MZI symbol as illustrated in FIG. 2. In the present embodiment, a product of a Givens rotation matrix and a vector may be represented by the MZI symbol.

### <<Clements’ Method>>

As described above, Clements’ method is known as a method for constructing an arbitrary unitary matrix with a Givens rotation matrix product. Clements’ method enables an arbitrary nxn unitary matrix to be constructed by products of n Givens rotation matrices and one diagonal matrix (where each element is a point on a unit circle of a complex plane). In other words, when the n Givens rotation matrices are denoted as R₁, ···, Rₙ and the diagonal matrix is denoted as D, then an arbitrary nxn unitary matrix U can be constructed by U = DRₙ⋯R₁. Because the unitary matrix U constructed in this way can be expressed by an n-layer structure formed by the products of the n Givens rotation matrices R with the exception of the diagonal matrix D, the unitary matrix U is also called a Givens rotation matrix product with an n-layer structure.

However, an arbitrary unitary matrix can be constructed by U = DR₁, only in a case where n = 2. While the unitary matrix may be called a Givens rotation matrix product with a two-layer structure even in this case, the unitary matrix is called a product of a Givens rotation matrix and a diagonal matrix or the like to avoid any misunderstanding.

### <<Linear Transformation Layer>>

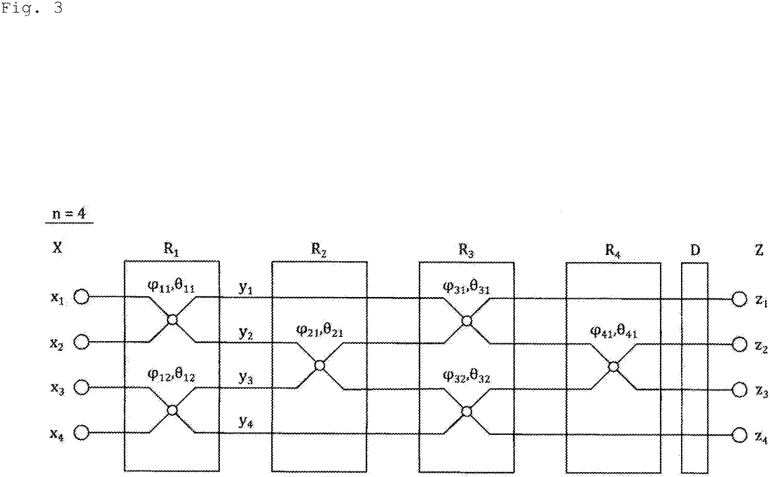

A linear transformation layer of a neural network using a Givens rotation matrix product with an n-layer structure as a structurally-constrained weight matrix can be achieved by Clements’ method described above. For example, when n = 4, a linear transformation layer of a neural network using a Givens rotation matrix product with an n-layer structure as a structurally-constrained weight matrix is as illustrated in FIG. 3. In the linear transformation layer illustrated in FIG. 3, with X = [x₁, x₂, x₃, x₄]^{t} as an input vector and Z = [z₁, z₂, z₃, z₄]^{t} as an output vector, a transformation expressed as Z = UX = DR₄R₃R₂R₁X is performed. Note that φ₁₁, θ₁₁, φ₁₂, θ₁₂, φ₂₁, θ₂₁, φ₃₁, θ₃₁, φ₃₂, θ₃₂, φ₄₁, θ₄₁ are parameters. In addition, R₁ is a matrix represented by a product of two commutative Givens rotation matrices (a product of a Givens rotation matrix including parameters (φ₁₁, θ₁₁) and a Givens rotation matrix including parameters (φ₁₂, θ₁₂) ) and, specifically,

$${R}_{1} = \left[\begin{matrix}\begin{matrix}{e}^{i {φ}_{11}} cos {θ}_{11} & - sin {θ}_{11} \\ {e}^{i {φ}_{11}} sin {θ}_{11} & cos {θ}_{11}\end{matrix} & \begin{matrix}0 & 0 \\ 0 & 0\end{matrix} \\ \begin{matrix}0 & 0 \\ 0 & 0\end{matrix} & \begin{matrix}{e}^{i {φ}_{12}} cos {θ}_{12} & - sin {θ}_{12} \\ {e}^{i {φ}_{12}} sin {θ}_{12} & cos {θ}_{12}\end{matrix}\end{matrix}\right] \qquad \text{[Math. 2]}$$

is obtained. Similarly, R₃ is also a matrix represented by a product of two commutative Givens rotation matrices (a product of a Givens rotation matrix including parameters (φ₃₁, θ₃₁) and a Givens rotation matrix including parameters (φ₃₂, θ₃₂) ) .

When a Givens rotation matrix product with an n-layer structure is used as a structurally-constrained weight matrix, an input vector of a linear transformation layer achieved by the weight matrix is transformed into an output vector through a sequential linear transformation performed n+1 times. With respect to the above, when an n×n matrix with an arbitrary complex number as an element is used as a weight matrix, an input vector of a linear transformation layer achieved by the weight matrix becomes an output vector by one linear transformation.

In this way, the weight matrix using the plurality of Givens rotation matrix products has a fine grain layer structure in which the linear transformation layer is decomposed into even finer layers. For this reason, when learning parameters of a neural network including a structurally-constrained weight matrix of which a fundamental matrix is a Givens rotation matrix by automatic differentiation, a computational graph becomes a deep graph formed by a large number of nodes and a large amount of calculation is required during backpropagation. As a result, learning the neural network also takes much time.

### <<Efficient Performance of Parameter Learning of Neural Network>>

In consideration thereof, in the present embodiment, two kinds of partial differentials necessary for backpropagation are formulated in advance, and partial differential equations thereof are used to efficiently perform parameter learning of a neural network including a structurally-constrained weight matrix using a Givens rotation matrix as a fundamental matrix. In this case, the two kinds of partial differentials are two kinds of equations being: an equation obtained by partial differentiation of a loss function by a parameter; and an equation obtained by partial differentiation by a conjugate variable of an input variable (in other words, a variable representing each element of an input vector) to the linear transformation layer.

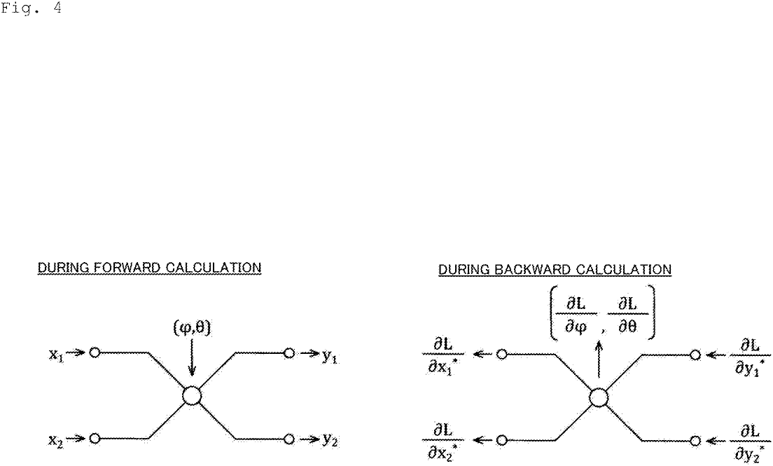

In the following description, as an example, it is assumed that n = 2 (in other words, an input vector and an output vector of the linear transformation layer are two-dimensional). Using the product of a Givens rotation matrix and a diagonal matrix as a structurally-constrained weight matrix, a Forward calculation and a Backward calculation of the linear transformation layer achieved by this weight matrix are as illustrated in FIG. 4. In this case, L denotes a loss function and φ and θ denote parameters. In addition, x₁, x₂ ∈ C denote input variables, y₁, y₂ ∈ C denote output variables (in other words, variables representing respective elements of an output vector), x₁* and x₂* denote conjugates of x₁ and x₂, respectively, and y₁* and y₂* denote conjugates of y₁ and y₂, respectively. Note that C represents a set of all complex numbers.

In this case, the partial differential equation of the first kind is an equation obtained by partially differentiating the loss function L by each of the parameters φ and θ, the partial differential equation of the second kind is an equation obtained by partially differentiating the loss function L by each of the conjugate variables x₁* and x₂*, and the equations are formulated in the following manner.

$$\frac{\partial L}{\partial φ} = 2 ⋅ Im \left({x}_{1} {}^{∗} \frac{\partial L}{\partial {x}_{1} {}^{∗}}\right) \qquad \text{[Math. 3]}$$

$$\frac{\partial L}{\partial θ} = 2 ⋅ Re \left({y}_{1} ∗ \frac{\partial L}{\partial {y}_{2} {}^{∗}} - {y}_{2} {}^{∗} \frac{\partial L}{\partial {y}_{1} {}^{∗}}\right)$$

$$\frac{\partial L}{\partial {x}_{1} {}^{∗}} = {e}^{- i φ} \left(\left(cos θ\right) \frac{\partial L}{\partial {y}_{1} {}^{∗}} + \left(sin θ\right) \frac{\partial L}{\partial {y}_{2} {}^{∗}}\right)$$

$$\frac{\partial L}{\partial {x}_{2} {}^{∗}} = \left(- sin θ\right) \frac{\partial L}{\partial {y}_{1} {}^{∗}} + \left(cos θ\right) \frac{\partial L}{\partial {y}_{2} {}^{∗}}$$

where Re ( · ) represents a real part and Im ( · ) represents an imaginary part. In this way, the four partial differentials described above can be formulated into a relatively simple form.

By formulating the partial differential equations illustrated in Math. 3 in advance, the number of nodes of a computational graph used during backpropagation can be reduced and the computational graph can be made relatively shallow. This is because, while it is necessary to perform many elemental operations of a sum, a difference, a product, and the like when calculating the two kinds of partial differentials described above in an ordinary computational graph, the number of such operations can be reduced by formulating the partial differential equations illustrated in Math. 3 in advance.

The reduction of the number of operations will be described in more detail. The partial differentials in the third and fourth lines in Math. 3 described above (the partial differential of the loss function L with respect to the conjugate variable x₁* and the partial differential of the loss function L with respect to the conjugate variable x₂*) can be expressed in a matrix form as follows.

$$\left(\begin{matrix}\partial L / \partial {x}_{1} {}^{∗} \\ \partial L / \partial {x}_{2} {}^{*}\end{matrix}\right) = \left(\begin{matrix}{e}^{- i φ} cos θ & {e}^{- i φ} sin θ \\ - sin θ & cos θ\end{matrix}\right) \left(\begin{matrix}\partial L / \partial {x}_{1} {}^{∗} \\ \partial L / \partial {x}_{2} {}^{∗}\end{matrix}\right) \qquad \text{[Math. 4]}$$

The matrix on the right side of Math. 4 is a conjugate transpose matrix of the matrix illustrated in Math. 1 described above used during a Forward calculation. Therefore, Math. 4 above can be calculated by simply holding matrix element values during Forward calculation and converting the values into conjugate values.

In addition, the partial differential in the first line of Math. 3 described above (the partial differential of the loss function L with respect to the parameter φ) can also be readily calculated from the conjugate variable x₁* of the input variable x₁ and the result of the partial differential in the third line of Math. 3 described above (the partial differential of the loss function L with respect to the conjugate variable x₁*).

In this manner, by reusing a value during Forward calculation, the number of calculations during Backward calculation can be reduced and a calculation cost thereof can be suppressed.

Hereinafter, the computational graph obtained by formulating the partial differential equation illustrated in Math. 3 described above in advance is also referred to as a “coarse-grained computational graph”. The coarse-grained computational graph is a graph that includes a smaller number of nodes and that is shallower than a normal computational graph (in other words, a graph before performing the formulation of the partial differentials illustrated in Math. 3 described above).

### <<Derivation of Partial Differential>>

The derivation of the partial differentials illustrated in Math. 3 described above will be described. A chain rule and Wirtinger derivative (or Wirtinger operator) are used to derive these partial differentials.

The linear transformation and the conjugate thereof in the linear transformation layer when n = 2 are expressed as:

$$\begin{matrix}\left(\begin{matrix}{y}_{1} \\ {y}_{2}\end{matrix}\right) = \left(\begin{matrix}{e}^{i φ} cos θ & - sin θ \\ {e}^{i φ} sin θ & cos θ\end{matrix}\right) \left(\begin{matrix}{x}_{1} \\ {x}_{2}\end{matrix}\right) \\ \left(\begin{matrix}{y}_{1} {}^{∗} \\ {y}_{2} {}^{∗}\end{matrix}\right) = \left(\begin{matrix}{e}^{- i φ} cos θ & - sin θ \\ {e}^{- i φ} sin θ & cos θ\end{matrix}\right) \left(\begin{matrix}{x}_{1} {}^{∗} \\ {x}_{2} {}^{∗}\end{matrix}\right)\end{matrix} \qquad \text{[Math. 5]}$$

In addition, the Wirtinger derivative is expressed as follows.

$$\begin{matrix}\frac{\partial }{\partial {x}_{h}} = \frac{1}{2} \left(\frac{\partial }{\partial Re \left({x}_{h}\right)} - i ⋅ \frac{\partial }{\partial Im \left({x}_{h}\right)}\right) \\ \frac{\partial }{\partial {x}_{h} {}^{∗}} = \frac{1}{2} \left(\frac{\partial }{\partial Re \left({x}_{h}\right)} + i ⋅ \frac{\partial }{\partial Im \left({x}_{h}\right)}\right)\end{matrix} \qquad \text{[Math. 6]}$$

In this case, the partial differential equation of the loss function L with respect to the parameter φ is derived as follows.

$$\begin{matrix}\frac{\partial L}{\partial φ} = \frac{\partial L}{\partial {y}_{1}} \frac{\partial {y}_{1}}{\partial φ} + \frac{\partial L}{\partial {y}_{1} {}^{∗}} \frac{\partial {y}_{1} {}^{∗}}{\partial φ} + \frac{\partial L}{\partial {y}_{2}} \frac{\partial {y}_{2}}{\partial φ} + \frac{\partial L}{\partial {y}_{2} {}^{∗}} \frac{\partial {y}_{2} {}^{∗}}{\partial φ} \\ = i \left({x}_{1} \frac{\partial L}{\partial {x}_{1}} + {x}_{1} {}^{∗} \frac{\partial L}{\partial {x}_{1} {}^{∗}}\right) \\ = 2 ⋅ Im \left({x}_{1} {}^{∗} \frac{\partial L}{\partial {x}_{1} {}^{∗}}\right)\end{matrix} \qquad \text{[Math. 7]}$$

Next, the partial differential equation of the loss function L with respect to the parameter θ is derived as follows.

$$\frac{\partial L}{\partial θ} = \frac{\partial L}{\partial {y}_{1}} \frac{\partial {y}_{1}}{\partial θ} + \frac{\partial L}{\partial {y}_{1} {}^{∗}} \frac{\partial {y}_{1} {}^{∗}}{\partial θ} + \frac{\partial L}{\partial {y}_{2}} \frac{\partial {y}_{2}}{\partial θ} + \frac{\partial L}{\partial {y}_{2} {}^{∗}} \frac{\partial {y}_{2} {}^{∗}}{\partial θ} \qquad \text{[Math. 8]}$$

$$= - {y}_{2} \frac{\partial L}{\partial {y}_{1}} - {y}_{2} {}^{∗} \frac{\partial L}{\partial {y}_{1} {}^{∗}} + {y}_{1} \frac{\partial L}{\partial {y}_{2}} + {y}_{1} {}^{∗} \frac{\partial L}{\partial {y}_{2} {}^{∗}}$$

$$= 2 ⋅ Re \left({y}_{1} {}^{∗} \frac{\partial L}{\partial {y}_{2} {}^{∗}} - {y}_{2} {}^{∗} \frac{\partial L}{\partial {y}_{1} {}^{∗}}\right)$$

Next, the partial differential equation of the loss function L with respect to the conjugate variable x₁* is derived as follows.

$$\frac{\partial L}{\partial {x}_{1} {}^{∗}} = \frac{\partial L}{\partial {y}_{1} {}^{∗}} \frac{\partial {y}_{1} {}^{∗}}{\partial {x}_{1} {}^{∗}} + \frac{\partial L}{\partial {y}_{2} {}^{∗}} \frac{\partial {y}_{2} {}^{∗}}{\partial {x}_{1} {}^{∗}} \qquad \text{[Math. 9]}$$

$$= {e}^{- i φ} \left(cos θ \frac{\partial L}{\partial {y}_{1} {}^{∗}} + sin θ \frac{\partial L}{\partial {y}_{2} {}^{∗}}\right)$$

In Math. 9, a relationship expressed as

$$\frac{\partial {y}_{1}}{\partial {x}_{1} {}^{∗}} = \frac{\partial {y}_{2}}{\partial {x}_{1} {}^{∗}} = 0 \qquad \text{[Math. 10]}$$

is utilized.

Next, the partial differential equation of the loss function L with respect to the conjugate variable x₂* is derived as follows.

$$\frac{\partial L}{\partial {x}_{2} {}^{*}} = \frac{\partial L}{\partial {y}_{1} {}^{∗}} \frac{\partial {y}_{1} {}^{∗}}{\partial {x}_{2} {}^{∗}} + \frac{\partial L}{\partial {y}_{2} {}^{∗}} \frac{\partial {y}_{2} {}^{∗}}{\partial {x}_{2} {}^{∗}} \qquad \text{[Math. 11]}$$

$$= - sin θ \frac{\partial L}{\partial {y}_{1} {}^{∗}} + cos θ \frac{\partial L}{\partial {y}_{2} {}^{∗}}$$

In Math. 11, a relationship expressed as

$$\frac{\partial {y}_{1}}{\partial {x}_{2} {}^{∗}} = \frac{\partial {y}_{2}}{\partial {x}_{2} {}^{∗}} = 0 \qquad \text{[Math. 12]}$$

is utilized.

In this manner, by utilizing a chain rule and Wirtinger derivative and utilizing the properties of a Givens rotation matrix, a partial differential of the loss function L can be formulated into a relatively simple form.

While the case of n = 2 has been mainly described in the present embodiment, n = 2 is merely an example and two kinds of partial differentials can be formulated in the same manner even when n is 3 or greater. In addition, in the present embodiment, while the matrix of the right side of Math. 1 described above has been described as an application example of Clements’ method, an application of Clements’ method is not limited thereto. For example, Non Patent Literature 2 described earlier describes a transposed matrix of the matrix on the right side of the Math. 1 described above in which θ has been replaced by -θ, and the present embodiment can be similarly applied to such a matrix. In addition, generally, a complex Givens rotation matrix is a generic term, and adding or subtracting a constant to or from the parameters θ, φ and multiplying the parameters θ, φ by a point on a unit circle of a complex plane also produce complex Givens rotation matrices to which the present embodiment can be similarly applied.

In addition, in addition to the partial differential of the linear transformation layer using the product of commutative Givens rotation matrices (for example, R₁ and R₃ in FIG. 3) as a weight matrix, the present embodiment may be expanded to formulating, in advance, a partial differential of a linear transformation layer using a product of non-commutative Givens rotation matrices (for example, a product of all of R₁ to R₄ in FIG. 3) as a single weight matrix.

### <Hardware Configuration>

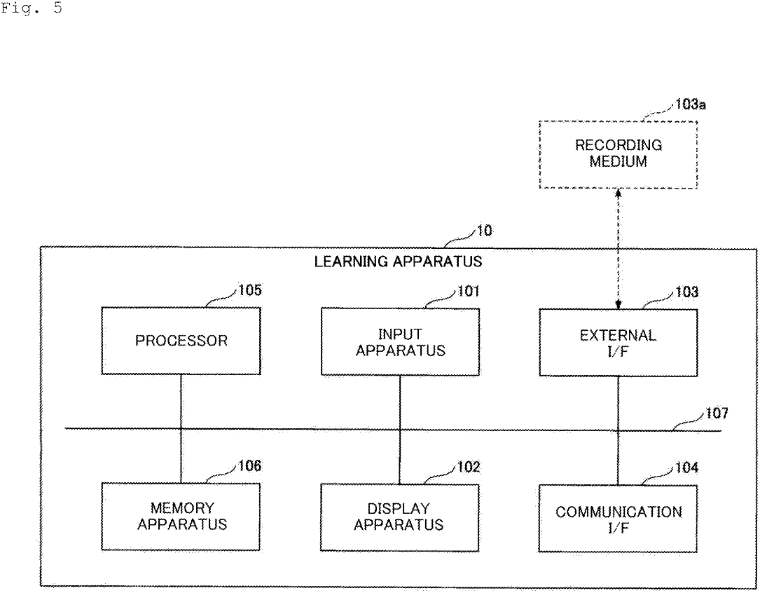

Next, FIG. 5 illustrates a hardware configuration of the learning apparatus 10 according to the present embodiment. As illustrated in FIG. 5, the learning apparatus 10 according to the present embodiment is implemented by a hardware configuration of a general computer or a computer system and includes an input apparatus 101, a display apparatus 102, an external I/F 103, a communication I/F 104, a processor 105, and a memory apparatus 106. The respective hardware components are communicatively connected via a bus 107.

The input apparatus 101 is, for example, a keyboard, a mouse, or a touch panel. The display apparatus 102 is, for example, a display. It is sufficient as long as the learning apparatus 10 includes either the input apparatus 101 or the display apparatus 102.

The external I/F 103 is an interface with an external device such as a recording medium 103a. The learning apparatus 10 can perform reading and writing from and to the recording medium 103a via the external I/F 103. Examples of the recording medium 103a include a CD (Compact Disc), a DVD (Digital Versatile Disk), an SD memory card (Secure Digital memory card), a USB (Universal Serial Bus) memory card, and so forth.

The communication I/F 104 is an interface for connecting the learning apparatus 10 to a communication network. Examples of the processor 105 include various calculating apparatuses such as a CPU (Central Processing Unit) and a GPU (Graphics Processing Unit). Examples of the memory apparatus 106 include various storage apparatuses such as an HDD (Hard Disk Drive), an SSD (Solid State Drive), a RAM (Random Access Memory), a ROM (Read Only Memory), and a flash memory.

The learning apparatus 10 according to the present embodiment can implement various functional units described hereinafter by including the hardware components illustrated in FIG. 5. The hardware components illustrated in FIG. 5 are an example and the learning apparatus 10 may include other hardware components. For example, the learning apparatus 10 may include a plurality of processors 105 or a plurality of memory apparatuses 106.

### <Functional Configuration>

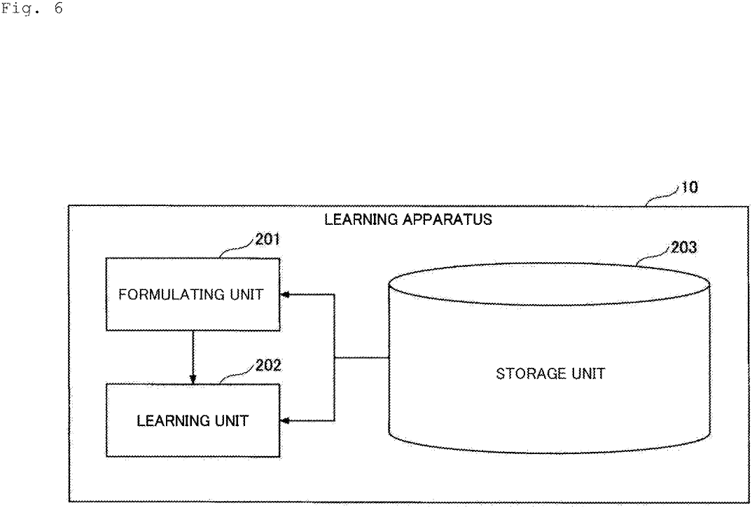

Next, FIG. 6 illustrates a functional configuration of the learning apparatus 10 according to the present embodiment. As illustrated in FIG. 6, as functional units, the learning apparatus 10 according to the present embodiment includes a formulating unit 201, a learning unit 202, and a storage unit 203. The formulating unit 201 and the learning unit 202 are achieved by, for example, processing that one or more programs installed on the learning apparatus 10 cause the processor 105 to execute. In addition, the storage unit 203 is implemented with, for example, the memory apparatus 106.

The formulating unit 201 formulates various partial differential equations related to the loss function L according to Math. 3 described above when, for example, n = 2. The learning unit 202 uses the partial differential equations formulated by the formulating unit 201 to learn parameters of the neural network by automatic differentiation using a coarse-grained computational graph. A value (partial differential value) of the partial differential equation formulated by the formulating unit 201 is calculated by forward calculation and backward calculation of the neural network.

The storage unit 203 stores various kinds of data (for example, the partial differential equations formulated by the formulating unit 201 and the parameters of the neural network).

In the learning apparatus 10 according to the present embodiment, the formulating unit 201 formulates various partial differential equations related to the loss function L (for example, when n = 2, formulates the partial differential equations represented by Math. 3 described above) and then the learning unit 202 learns parameters of the neural network by using the various partial differential equations. Accordingly, high-speed learning can be achieved by eliminating an amount of calculation when learning parameters of the neural network including a structurally-constrained weight matrix using a Givens rotation matrix as a fundamental matrix. Note that because a Givens rotation matrix product with an n-layer structure can construct an arbitrary unitary matrix (naturally, a given specific unitary matrix can also be constructed), learning of the neural network using an arbitrary unitary matrix as a weight matrix can be accelerated.

### <Experiment>

Next, an experiment for comparing the learning apparatus 10 according to the present embodiment with a conventional method will be described.

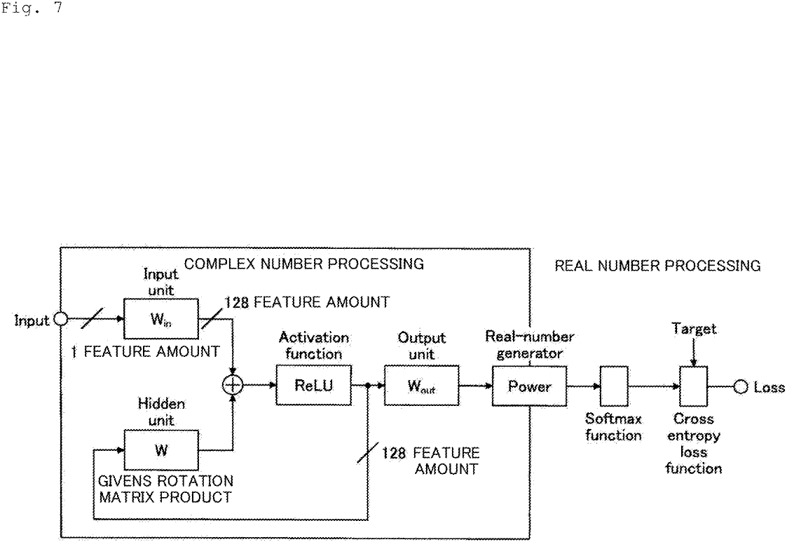

In the present embodiment, an Elman-type simple recurrent neural network (RNN) illustrated in FIG. 7 is used, and image data MNIST for handwritten numeral recognition is used as training data. MNIST includes images of numerals with each image being a gray scale of 28 × 28 = 784 pixels, and the handwritten numerals being ten numerals from 0 to 9, which are used for a problem of recognizing ten numeral classes. In FIG. 7, “1 feature amount” and “128 feature amount” respectively refer to a feature amount (feature vector) represented by a one-dimensional vector and a feature amount (feature vector) represented by a 128-dimensional vector.

From input, being an input terminal, one pixel (minibatch is used) is input to an input unit (Input unit). The input unit is a linear transformation unit which uses an arbitrary complex number as a weight matrix Wᵢₙ (128 rows, 1 column).

A hidden layer (Hidden unit) is a linear transformation unit which uses a Givens rotation matrix product W as a weight matrix (128 rows, 128 columns).

An output from the input unit and an output from the hidden layer are added together and input to a ReLU being an activation function (Activation function). An output of ReLU is fed back to the hidden layer but also input to an output unit (Output unit). The output unit is a linear transformation unit that uses an arbitrary complex number as a weight matrix Wₒᵤₜ (10 rows, 128 columns).

A complex number output by the output unit is converted by a real number generator into a real number by using power for calculating a square of an absolute value of the complex number. Once processing for 784 pixels of one image is completed, a class identification problem is evaluated. In the evaluation, a Softmax function and a Cross entropy loss function are used and correct answer numeral data, being a target, is input to the Cross entropy loss function.

In this case, the Givens rotation matrix product being the hidden layer is formed by four layers that can achieve only a limited unitary matrix instead of 784 layers that can construct an arbitrary unitary matrix, and a diagonal matrix is omitted.

In the setting described above, learning of the Elman-type simple RNN was performed using the learning apparatus 10 according to the present embodiment and using a conventional method, respectively. As the conventional method, a pytorch code using default of pytorch on the PyTorch platform was adopted (hereinafter, referred to as “AD-py”). In the learning apparatus 10 according to the present embodiment, the linear transformation layer illustrated in FIG. 3 was implemented with C++ (hereinafter, referred to as “BP-cpp”).

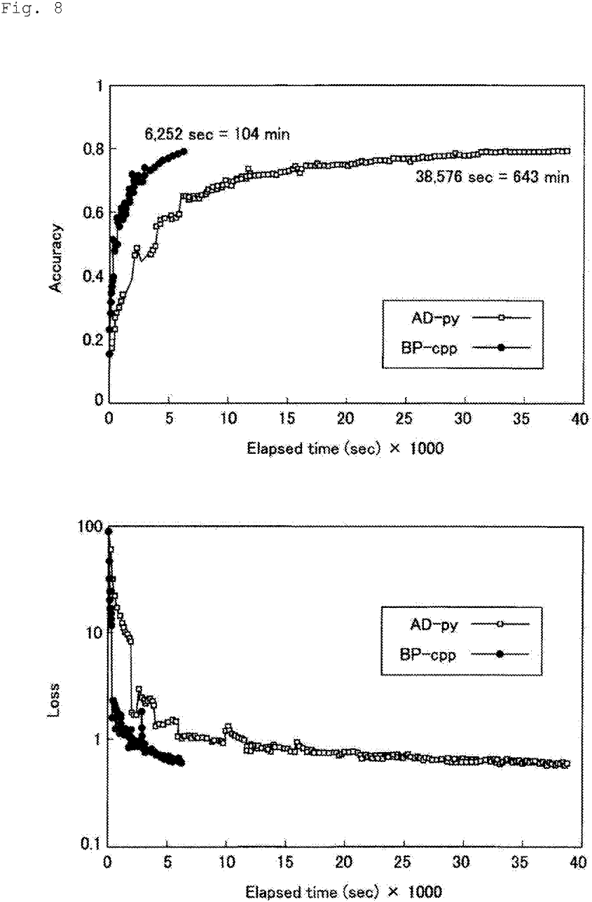

FIG. 8 illustrates a relationship between accuracy and elapsed time and a relationship between loss and elapsed time in this case. As illustrated in FIG. 8, it is found that high speed learning is achieved in BP-cpp as compared to AD-py.

In addition, a result of a comparison of elapsed times per one epoch is illustrated in Table 1 below.

TABLE 1

| Method | Elapsed time (sec)/epoch | Time rate | Speed |
|---|---|---|---|
| BP-cpp | 312.6 | 0.16 | 6.2 |
| AD-py | 1928.8 | 1.00 | 1.0 |

As illustrated in Table 1 above, when the elapsed time per one epoch of AD-py is 1.00, the elapsed time in BP-cpp is 0.16, which demonstrates that an increase in speed by a factor of approximately 6.2 is realized.

In addition, using the perf tool that is a tool for reading a performance counter provided in a CPU, a comparison of the number of instructions being speed deterioration factors (#instructions: retired instruction or completed instruction), the number of data loads of a last level cache (#LLC-loads: Last-level cache data loads), and the number of data load misses of the last level (#LLCM: Last-level cache data load misses) was performed. A result of the comparison is illustrated in Table 2 below.

TABLE 2

| | | | |
|---|---|---|---|
| Method | #instructions (rate) | #LLC-load (rate) | #LLCM (rate) |
| BP-cpp | 1.43e+10 (0.81) | 4.09e+6 (0.13) | 6.73e+5 (0.05) |
| AD-py | 1.76e+10 (1.00) | 3.18e+7 (1.00) | 1.25e+7 (1.00) |

As illustrated in Table 2 above, it is found that all of #instructions, #LLC-loads, and #LLCM are fewer in BP-cpp than in AD-py. Therefore, it is found that BP-cpp can reduce speed deterioration factors.

### Second Embodiment

Next, a second embodiment will be described. In the present embodiment, a case of efficiently performing parameter learning of a neural network including a linear transformation layer achieved by a Fang-type matrix will be described.

In the second embodiment, differences from the first embodiment will be mainly described and descriptions of components substantially the same as those in the first embodiment will be omitted. In particular, the learning apparatus 10 according to the present embodiment can be implemented with a hardware configuration and a functional configuration substantially the same as those of the first embodiment.

### <Linear Transformation Layer Achieved by Fang-Type Matrix>

A Fang-type matrix is a matrix expressed as R = BS₂·PS_{θ}·BS₁·PS_{φ}. In this case:

$$\begin{matrix}P {S}_{φ} = \left(\begin{matrix}{e}^{i φ} & 0 \\ 0 & 1\end{matrix}\right) P {S}_{θ} = \left(\begin{matrix}{e}^{i θ} & 0 \\ 0 & 1\end{matrix}\right) B {S}_{1} = \frac{1}{\sqrt{2}} \left(\begin{matrix}1 & i \\ i & 1\end{matrix}\right) \\ B {S}_{2} = \frac{1}{\sqrt{2}} \left(\begin{matrix}1 & i \\ i & 1\end{matrix}\right)\end{matrix} \qquad \text{[Math. 13]}$$

Therefore, the Fang-type matrix R is expressed as:

$$R = B {S}_{2} ⋅ P {S}_{θ} ⋅ B {S}_{1} ⋅ P {S}_{φ} \qquad \text{[Math. 14]}$$

$$= \frac{1}{2} \left(\begin{matrix}1 & i \\ i & 1\end{matrix}\right) \left(\begin{matrix}{e}^{i θ} & 0 \\ 0 & 1\end{matrix}\right) \left(\begin{matrix}1 & i \\ i & 1\end{matrix}\right) \left(\begin{matrix}{e}^{i φ} & 0 \\ 0 & 1\end{matrix}\right)$$

$$= \frac{1}{2} \left(\begin{matrix}{e}^{i φ} \left({e}^{i θ} - 1\right) & i \left({e}^{i θ} + 1\right) \\ i {e}^{i φ} \left({e}^{i θ} + 1\right) & - \left({e}^{i θ} - 1\right)\end{matrix}\right)$$

$$= i {e}^{i \left(θ / 2\right)} \left(\begin{matrix}{e}^{i φ} sin \left(θ / 2\right) & cos \left(θ / 2\right) \\ {e}^{i φ} cos \left(θ / 2\right) & - sin \left(θ / 2\right)\end{matrix}\right)$$

For details of a Fang-type matrix, for example, refer to Reference Literature 1 “Michel Y.-S. Fang, Sasikanth Manipatruni, Casimir Wierzynski, Amir Khosrowshahi, and Michel R. DeWeese, “Design of optical networks with component imprecisions”, Optics Express, vol. 27, No. 10, pp. 14009-14029, 2019” and the like.

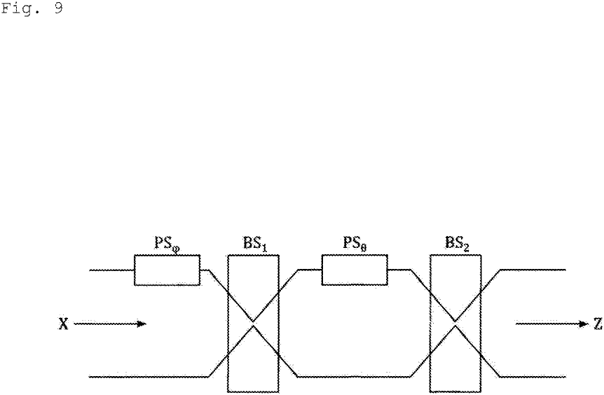

FIG. 9 illustrates a linear transformation layer using the Fang-type matrix R as a weight matrix. In the linear transformation layer illustrated in FIG. 9, a transformation expressed as Z = RX = BS₂·PS_{θ}·BS₁·PS_{φ}·X is performed, with X denoting an input vector and Z denoting an output vector, respectively.

In this case, the Fang-type matrix R illustrated in Math. 14 above can be modified to

$$R = \frac{1}{2} \left(\begin{matrix}{e}^{i φ} \left({e}^{i θ} - 1\right) & i \left({e}^{i θ} + 1\right) \\ i {e}^{i φ} \left({e}^{i θ} + 1\right) & - \left({e}^{i θ} - 1\right)\end{matrix}\right) \qquad \text{[Math. 15]}$$

Therefore, the partial differential equation of the loss function L with respect to each of the parameters φ and θ and the partial differential equation of the loss function L with respect to each of the conjugate variables x₁* and x₂* are formulated as follows.

$$\frac{\partial L}{\partial {x}_{1} {}^{∗}} = \frac{{e}^{- i φ}}{2} \left\{\left({e}^{- i θ} - 1\right) \frac{\partial L}{\partial {z}_{1} {}^{∗}} - i \left({e}^{- i θ} + 1\right) \frac{\partial L}{\partial {z}_{2} {}^{∗}}\right\} \qquad \text{[Math. 16]}$$

$$\frac{\partial L}{\partial {x}_{2} {}^{∗}} = \frac{- 1}{2} \left\{i \left({e}^{- i θ} + 1\right) \frac{\partial L}{\partial {z}_{1} {}^{∗}} + \left({e}^{- i θ} - 1\right) \frac{\partial L}{\partial {z}_{2} {}^{∗}}\right\}$$

$$\frac{\partial L}{\partial φ} = 2 ⋅ Im \left({x}_{1} {}^{∗} \frac{\partial L}{\partial {x}_{1} {}^{∗}}\right)$$

$$\frac{\partial L}{\partial θ} = Im \left({z}_{1} {}^{∗} \frac{\partial L}{\partial {z}_{1} {}^{∗}} + {z}_{2} {}^{∗} \frac{\partial L}{\partial {z}_{2} {}^{∗}}\right) + Re \left({z}_{2} {}^{∗} \frac{\partial L}{\partial {z}_{1} {}^{∗}} - {z}_{1} {}^{∗} \frac{\partial L}{\partial {z}_{2} {}^{∗}}\right)$$

In consideration thereof, in the learning apparatus 10 according to the present embodiment, after the various partial differential equations illustrated in Math. 16 are formulated by the formulating unit 201, the learning unit 202 learns the parameters of the neural network including the linear transformation layer illustrated in FIG. 9 by using the various partial differential equations. Accordingly, higher-speed parameter learning of the neural network including the linear transformation layer using the Fang-type matrix R as a weight matrix can be achieved.

In addition to the Fang-type matrix, for example, a partial differential of a transposed matrix of the matrix described in Non Patent Literature 2 mentioned earlier can also be formulated in a similar manner. Specifically, Non Patent Literature 2 describes a matrix representation of a transposed matrix of the Givens rotation matrix illustrated in Math. 1 described earlier in which θ has been replaced with -θ (Expression (9) in Non Patent Literature 2). The partial differential equation of the loss function L with respect to each of the parameters φ and θ and the partial differential equation of the loss function L with respect to each of the conjugate variables x₁* and x₂* can also be formulated in a similar manner with respect to a linear transformation layer using this matrix as a weight matrix.

### Third Embodiment

Next, a third embodiment will be described. In the present embodiment, a case will be described in which, after a Fang-type matrix is decomposed into a product of two matrices, parameter learning of a neural network including a linear transformation layer achieved by matrices including the matrix product is efficiently performed.

In the third embodiment, differences from the second embodiment will be mainly described and descriptions of components substantially the same as those in the second embodiment will be omitted. In particular, the learning apparatus 10 according to the present embodiment can be implemented with a hardware configuration and a functional configuration substantially the same as those of the second embodiment.

### <Linear Transformation Layer Achieved by Matrices Obtained by Decomposing Fang-Type matrix>

The Fang-type matrix R can be decomposed into a matrix product of two matrices as follows.

$$R = B {S}_{2} ⋅ P {S}_{θ} ⋅ B {S}_{1} ⋅ P {S}_{φ} \qquad \text{[Math. 17]}$$

$$= \frac{1}{2} \left(\begin{matrix}1 & i \\ i & 1\end{matrix}\right) \left(\begin{matrix}{e}^{i θ} & 0 \\ 0 & 1\end{matrix}\right) \left(\begin{matrix}1 & i \\ i & 1\end{matrix}\right) \left(\begin{matrix}{e}^{i φ} & 0 \\ 0 & 1\end{matrix}\right)$$

$$= \frac{1}{\sqrt{2}} \left(\begin{matrix}{e}^{i θ} & i \\ i {e}^{i θ} & 1\end{matrix}\right) \times \frac{1}{\sqrt{2}} \left(\begin{matrix}{e}^{i φ} & i \\ i {e}^{i φ} & 1\end{matrix}\right)$$

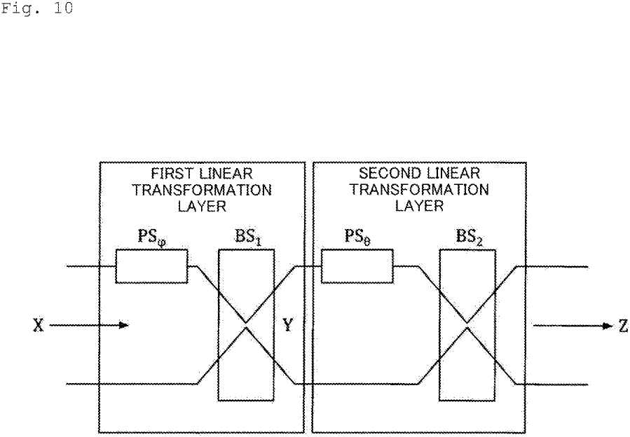

In this case, a first term and a second term of the matrix product described above are identical matrix representations which only differ from each other in parameter names. Therefore, the linear transformation layer using the Fang-type matrix R as a weight matrix can be decomposed into two linear transformation layers (a first linear transformation layer and a second linear transformation layer) which only differ from each other in parameter names as illustrated in FIG. 10.

In this case, in the first linear transformation layer, a transformation expressed as

$$\left(\begin{matrix}{y}_{1} \\ {y}_{2}\end{matrix}\right) = \frac{1}{\sqrt{2}} \left(\begin{matrix}{e}^{i φ} & i \\ i {e}^{i φ} & 1\end{matrix}\right) \left(\begin{matrix}{x}_{1} \\ {x}_{2}\end{matrix}\right) \qquad \text{[Math. 18]}$$

is performed and, in the second linear transformation layer, a transformation expressed as

$$\left(\begin{matrix}{z}_{1} \\ {z}_{2}\end{matrix}\right) = \frac{1}{\sqrt{2}} \left(\begin{matrix}{e}^{i θ} & i \\ i {e}^{i θ} & 1\end{matrix}\right) \left(\begin{matrix}{y}_{1} \\ {y}_{2}\end{matrix}\right) \qquad \text{[Math. 19]}$$

is performed.

Therefore, in the first linear transformation layer, a partial differential equation of the loss function L related to the parameter φ and a partial differential equation of the loss function L related to each of the conjugate variables x₁* and x₂* are formulated as follows.

$$\frac{\partial L}{\partial {x}_{1} {}^{∗}} = \frac{\partial L}{\partial {y}_{1} {}^{∗}} \frac{\partial {y}_{1} {}^{∗}}{\partial {x}_{1} {}^{∗}} + \frac{\partial L}{\partial {y}_{2} {}^{∗}} \frac{\partial {y}_{2} {}^{∗}}{\partial {x}_{1} {}^{∗}} = \frac{{e}^{- i φ}}{\sqrt{2}} \left(\frac{\partial L}{\partial {y}_{1} {}^{∗}} - i \frac{\partial L}{\partial {y}_{2} {}^{∗}}\right) \qquad \text{[Math. 20]}$$

$$\frac{\partial L}{\partial {x}_{2} \text{} *} = \frac{\partial L}{\partial {y}_{1} \text{} *} \frac{\partial {y}_{1} \text{} *}{\partial {x}_{2} \text{} *} + \frac{\partial L}{\partial {y}_{2} \text{} *} \frac{\partial {y}_{2} \text{} *}{\partial {x}_{2} \text{} *} = \frac{1}{\sqrt{2}} \left(- i + \frac{\partial L}{\partial {y}_{2} \text{} *}\right)$$

$$\frac{\partial L}{\partial φ} = 2 ⋅ Im \left({x}_{1} * \frac{\partial L}{\partial {x}_{1} \text{} *}\right)$$

In the second linear transformation layer, by replacing φ above with θ, x above with y, and y above with z, a partial differential equation of the loss function L related to the parameter θ and a partial differential equation of the loss function L related to each of the conjugate variables y₁* and y₂* are formulated in a similar manner.

In consideration thereof, in the learning apparatus 10 according to the present embodiment, after the various partial differential equations described earlier are formulated by the formulating unit 201, the learning unit 202 learns parameters of a neural network including the first linear transformation layer and the second linear transformation layer illustrated in FIG. 10 by using the various partial differential equations. Accordingly, high-speed parameter learning of the neural network including two linear transformation layers using each of two matrices obtained by performing matrix decomposition of the Fang-type matrix as a weight matrix can be achieved.

### Other Examples

A 2×2 unitary matrix A ∈ U (2) can be expressed by a product of e^{i(ρ/2)} ∈ U(1), ρ ∈ RN, and U ∈ SU (2), where U(n) represents an n-th order unitary group, SU(n) represents an n-th order special unitary group, and RN represents all real numbers.

In other words, the 2×2 unitary matrix A is expressed as

$$A = \left(\begin{matrix}{a}_{11} & {a}_{12} \\ {a}_{21} & {a}_{22}\end{matrix}\right) \qquad \text{[Math. 21]}$$

where aⱼₕ ∈ C and j, h = 1, 2. In addition, A satisfies AA^{†} = A^{†}A = I and also detA = e^{iρ} (where ρ ∈ RN) if |detA| = 1. In this case, detA represents a determinant of the matrix A.

In addition, a 2×2 special unitary matrix U is expressed as

$$U = \left(\begin{matrix}α & β \\ - β * & α \text{[Math. 22]} *\end{matrix}\right)$$

where α, β ∈ C. In addition, U satisfies detU = αα* + ββ* = +1. Note that U includes three independent variables (because a fourth variable is uniquely determined by the other three independent variables).

In this case, A can be expressed as A = e^{i(ρ/2)}U.

In this case, the special unitary matrix U described above can be expressed by a linear sum of Pauli matrices σ₁, σ₂, σ₃ and an identity matrix σ₄ = I. Specifically, when p₁, p₂, p₃, p₄ ∈ RN, α = p₄ + i·p₃, and β = p₂ + i·p₁, then U can be expressed as follows, where i represents an imaginary unit.

$$U = \left(\begin{matrix}{p}_{4} + i ⋅ {p}_{3} & {p}_{2} + i ⋅ {p}_{1} \\ - {p}_{2} + i ⋅ {p}_{1} & {p}_{4} - i ⋅ {p}_{3}\end{matrix}\right) \qquad \text{[Math. 23]}$$

$$= i ⋅ {p}_{1} \left(\begin{matrix}0 & 1 \\ 1 & 0\end{matrix}\right) + i ⋅ {p}_{2} \left(\begin{matrix}0 & - i \\ i & 0\end{matrix}\right) + i ⋅ {p}_{3} \left(\begin{matrix}1 & 0 \\ 0 & - 1\end{matrix}\right) + {p}_{4} \left(\begin{matrix}1 & 0 \\ 0 & 1\end{matrix}\right)$$

Furthermore,

$${σ}_{1} = \left(\begin{matrix}0 & 1 \\ 1 & 0\end{matrix}\right) {σ}_{2} = \left(\begin{matrix}0 & - i \\ i & 0\end{matrix}\right) {σ}_{3} = \left(\begin{matrix}1 & 0 \\ 0 & - 1\end{matrix}\right) {σ}_{4} = \left(\begin{matrix}1 & 0 \\ 0 & 1\end{matrix}\right) \qquad \text{[Math. 24]}$$

is provided. Therefore, U can be expressed as U = i·p₁σ₁ + i·p₂σ₂ + i·p₃σ₃ + p₄σ₄. Note that, for j = 1, 2, 3, Trace (σⱼ) = 0, det (σⱼ) = -1, σⱼ² = I. Furthermore, σ₁σ₂σ₃ = iI, σ₁σ₂ = -σ₂σ₁ = iσ₃, σ₂σ₃ = -σ₃σ₂ = iσ₁, and σ₃σ₁ = -σ₁σ₃ = -iσ₂ are satisfied.

From the above, it is found that σ₁, σ₂, σ₃, and σ₄ are mutually linear-independent orthogonal bases in a four-dimensional complex vector space formed by a 2×2 complex matrix.

As an example, when σ₂ and σ₃ are adopted as matrix generators, the special unitary matrix U can be expressed as U (ω, θ, φ) = U₃ (ω) U₂ (θ) U₁ (φ), where

$${U}_{3} \left(ω\right) = {e}^{i \left(\frac{ω}{2}\right) {σ}_{3}} = \left(\begin{matrix}{e}^{i \left(\frac{ω}{2}\right)} & 0 \\ 0 & {e}^{- i \left(\frac{ω}{2}\right)}\end{matrix}\right) = {e}^{- i \left(\frac{ω}{2}\right)} \left(\begin{matrix}{e}^{i ω} & 0 \\ 0 & 1\end{matrix}\right) \qquad \text{[Math. 25]}$$

$${U}_{3} \left(φ\right) = {e}^{i \left(\frac{φ}{2}\right) {σ}_{3}} = \left(\begin{matrix}{e}^{i \left(\frac{φ}{2}\right)} & 0 \\ 0 & {e}^{- i \left(\frac{φ}{2}\right)}\end{matrix}\right) = {e}^{- i \left(\frac{φ}{2}\right)} \left(\begin{matrix}{e}^{i φ} & 0 \\ 0 & 1\end{matrix}\right)$$

$${U}_{2} \left(θ\right) = {e}^{i \left(\frac{θ}{2}\right) {σ}_{2}} = \left(\begin{matrix}cos \left(θ / 2\right) & sin \left(θ / 2\right) \\ - sin \left(θ / 2\right) & cos \left(θ / 2\right)\end{matrix}\right)$$

In this case, e^{x} denotes an exponential function of a matrix X and is defined by

$${e}^{X} = {\sum }_{k = 0}^{∞} \frac{{X}^{k}}{k !} \qquad \text{[Math. 26]}$$

where X⁰ = I.

Thus, the special unitary matrix U can be expressed as:

$$U \left(ω , θ , φ\right) = {e}^{- i \left(\frac{ω}{2}\right)} \left(\begin{matrix}{e}^{i ω} & 0 \\ 0 & 1\end{matrix}\right) {e}^{- i \left(\frac{φ}{2}\right)} \left(\begin{matrix}{e}^{i φ} cos \left(θ / 2\right) & sin \left(θ / 2\right) \\ - {e}^{i φ} sin \left(θ / 2\right) & cos \left(θ / 2\right)\end{matrix}\right) \qquad \text{[Math. 27]}$$

On the right side of Math. 27 described above, the first term and the second term are diagonal matrices and the third term and the fourth term are special unitary matrices.

Accordingly, when σ₂ and σ₃ are adopted as matrix generators, an arbitrary 2×2 unitary matrix A can be expressed as:

$$A = {e}^{i \left(ρ / 2\right)} {e}^{- i \left(\frac{ω}{2}\right)} \left(\begin{matrix}{e}^{i ω} & 0 \\ 0 & 1\end{matrix}\right) {e}^{- i \left(\frac{φ}{2}\right)} \left(\begin{matrix}{e}^{i φ} cos \left(θ / 2\right) & sin \left(θ / 2\right) \\ - {e}^{i φ} sin \left(θ / 2\right) & cos \left(θ / 2\right)\end{matrix}\right) \qquad \text{[Math. 28]}$$

On the right side of Math. 28 described above, the first to third terms are diagonal matrices and the fourth term and the fifth term are special unitary matrices. In other words, when σ₂ and σ₃ are adopted as matrix generators, an arbitrary 2×2 unitary matrix A can be expressed as a product of a diagonal matrix and a special unitary matrix. Therefore, in the following description, formulation of a partial differential of the special unitary matrix being denoted as V will be considered. While σ₂ and σ₃ have been adopted as matrix generators as an example in the present embodiment, for example, the present embodiment can also be applied to a case where σ₁ and σ₃ are adopted as matrix generators.

When the fourth term and the fifth term of Math. 28 described above are denoted as V,

$$V = {e}^{- i \left(\frac{φ}{2}\right)} \left(\begin{matrix}{e}^{i φ} cos \left(θ / 2\right) & sin \left(θ / 2\right) \\ - {e}^{i φ} sin \left(θ / 2\right) & cos \left(θ / 2\right)\end{matrix}\right) \qquad \text{[Math. 29]}$$

is obtained.

Hereinafter, for the sake of simplicity, after multiplying each element of the matrix of the second item by the first item of Math. 29 described above, φ/2 is replaced by φ and θ/2 is replaced by θ to produce a matrix W (this is possible without loss of generality). In other words, the following matrix is defined as W.

$$W = \left(\begin{matrix}{e}^{i φ} cos θ & {e}^{- i φ} sin θ \\ - {e}^{i φ} sin θ & {e}^{- i φ} cos θ\end{matrix}\right) \qquad \text{[Math. 30]}$$

A determinant detW of the matrix W is +1 and W is a representation matrix of SU (2). The complex Givens rotation matrix illustrated in Math. 1 described earlier becomes the representation matrix of SU(2) by being multiplied by exp(-iφ/2) and the Fang-type matrix illustrated in Math. 13 described earlier becomes the representation matrix of SU(2) by being multiplied by i·exp(-i(θ + φ)/2). These representation matrices can be called rotation matrices.

In this case, a linear transformation by the matrix W and a conjugate thereof are:

$$\begin{matrix}\left(\begin{matrix}{y}_{1} \\ {y}_{2}\end{matrix}\right) = \left(\begin{matrix}{e}^{i φ} cos θ & {e}^{- i φ} sin θ \\ - {e}^{i φ} sin θ & {e}^{- i φ} cos θ\end{matrix}\right) \left(\begin{matrix}{x}_{1} \\ {x}_{2}\end{matrix}\right) \\ \left(\begin{matrix}{y}_{1} \text{} * \\ {y}_{2} \text{} *\end{matrix}\right) = \left(\begin{matrix}{e}^{- i φ} cos θ & {e}^{i φ} sin θ \\ - {e}^{- i φ} sin θ & {e}^{i φ} cos θ\end{matrix}\right) \left(\begin{matrix}{x}_{1} \text{} * \\ {x}_{2} \text{} *\end{matrix}\right)\end{matrix} \qquad \text{[Math. 31]}$$

Therefore, the partial differential equation of the loss function L with respect to each of the parameters φ and θ and the partial differential equation of the loss function L with respect to each of the conjugate variables x₁* and x₂* are formulated as follows.

$$\frac{\partial L}{\partial {x}_{1} \text{} *} = \frac{\partial L}{\partial {y}_{1} \text{} *} \frac{\partial {y}_{1} \text{} *}{\partial {x}_{1} \text{} *} + \frac{\partial L}{\partial {y}_{2} \text{} *} \frac{\partial {y}_{2} \text{} *}{\partial {x}_{1} \text{} *} = {e}^{- i φ} \left(cos θ \frac{\partial L}{\partial {y}_{1} \text{} *} - sin θ \frac{\partial L}{\partial {y}_{2} \text{} *}\right) \qquad \text{[Math. 32]}$$

$$\frac{\partial L}{\partial {x}_{2} \text{} *} = \frac{\partial L}{\partial {y}_{1} \text{} *} \frac{\partial {y}_{1} \text{} *}{\partial {x}_{2} \text{} *} + \frac{\partial L}{\partial {y}_{2} \text{} *} \frac{\partial {y}_{2} \text{} *}{\partial {x}_{2} \text{} *} = {e}^{i φ} \left(sin θ \frac{\partial L}{\partial {y}_{1} \text{} *} + cos θ \frac{\partial L}{\partial {y}_{2} \text{} *}\right)$$

$$\frac{\partial L}{\partial φ} = 2 ⋅ Im \left({x}_{1} * \frac{\partial L}{\partial {x}_{1} \text{} *} - {x}_{2} * \frac{\partial L}{\partial {x}_{2} \text{} *}\right)$$

$$\frac{\partial L}{\partial θ} = 2 ⋅ Re \left({y}_{2} * \frac{\partial L}{\partial {y}_{1} \text{} *} - {y}_{1} * \frac{\partial L}{\partial {y}_{2} \text{} *}\right)$$

Accordingly, the parameter learning of the neural network including the linear transformation layer using an arbitrary 2×2 unitary matrix A as a weight matrix can be efficiently performed. Note that the formulation of the partial differentials is performed by the formulating unit 201 and the parameter learning is performed by the learning unit 202.

Derivation of the partial differential equation of the loss function L with respect to each of the parameters φ and θ will be described below. First, note that

$$\frac{\partial L}{\partial {x}_{1}} = \frac{\partial L}{\partial {y}_{1}} \frac{\partial {y}_{1}}{\partial {x}_{1}} + \frac{\partial L}{\partial {y}_{2}} \frac{\partial {y}_{2}}{\partial {x}_{1}} = {e}^{i φ} \left(cos θ \frac{\partial L}{\partial {y}_{1}} - sin θ \frac{\partial L}{\partial {y}_{2}}\right) \qquad \text{[Math. 33]}$$

$$\frac{\partial L}{\partial {x}_{2}} = \frac{\partial L}{\partial {y}_{1}} \frac{\partial {y}_{1}}{\partial {x}_{2}} + \frac{\partial L}{\partial {y}_{2}} \frac{\partial {y}_{2}}{\partial {x}_{2}} = {e}^{- i φ} \left(sin θ \frac{\partial L}{\partial {y}_{1}} + cos θ \frac{\partial L}{\partial {y}_{2}}\right)$$

is satisfied. Using this relationship enables the partial differential equation of the loss function L with respect to the parameter φ to be derived as follows.

$$\frac{\partial L}{\partial φ} = \frac{\partial L}{\partial {y}_{1}} \frac{\partial {y}_{1}}{\partial φ} + \frac{\partial L}{\partial {y}_{2}} \frac{\partial {y}_{2}}{\partial φ} + \frac{\partial L}{\partial {y}_{1} \text{} *} \frac{\partial {y}_{1} \text{} *}{\partial φ} + \frac{\partial L}{\partial {y}_{2} \text{} *} \frac{\partial {y}_{2} \text{} *}{\partial φ} \qquad \text{[Math. 34]}$$

$$= i {x}_{1} {e}^{i φ} \left(cos θ \frac{\partial L}{\partial {y}_{1}} - sin θ \frac{\partial L}{\partial {y}_{2}}\right) - i {x}_{2} {e}^{- i φ} \left(sin θ \frac{\partial L}{\partial {y}_{1}} + cos θ \frac{\partial L}{\partial {y}_{2}}\right)$$

$$\begin{matrix}- i {x}_{1} \text{} * {e}^{- i φ} \left(cos θ \frac{\partial L}{\partial {y}_{1} \text{} *} - sin θ \frac{\partial L}{\partial {y}_{2} \text{} *}\right) + \\ i {x}_{2} \text{} * {e}^{i φ} \left(sin θ \frac{\partial L}{\partial {y}_{1} \text{} *} +\right) \left(cos θ \frac{\partial L}{\partial {y}_{2} \text{} *}\right)\end{matrix}$$

$$= i \left({x}_{1} \frac{\partial L}{\partial {x}_{1}} - {x}_{1} * \frac{\partial L}{\partial {x}_{1} \text{} *}\right) - i \left({x}_{2} \frac{\partial L}{\partial {x}_{2}} - {x}_{2} \text{} * \frac{\partial L}{\partial {x}_{2} \text{} *}\right)$$

$$\begin{matrix}= \left(Re \left({x}_{1}\right) \frac{\partial L}{\partial Im \left({x}_{1}\right)} - Im \left({x}_{1}\right) \frac{\partial L}{\partial Re \left({x}_{1}\right)}\right) - \\ \left(Re \left({x}_{2}\right) \frac{\partial L}{\partial Im \left({x}_{2}\right)} -\right) \left(Im \left({x}_{2}\right) \frac{\partial L}{\partial Re \left({x}_{2}\right)}\right)\end{matrix}$$

$$= 2 ⋅ Im \left({x}_{1} * \frac{\partial L}{\partial {x}_{1} \text{} *} - {x}_{2} * \frac{\partial L}{\partial {x}_{2} \text{} *}\right)$$

Similarly, the partial differential equation of the loss function L with respect to the parameter θ is derived as follows.

$$\frac{\partial L}{\partial θ} = \frac{\partial L}{\partial {y}_{1}} \frac{\partial {y}_{1}}{\partial θ} + \frac{\partial L}{\partial {y}_{2}} \frac{\partial {y}_{2}}{\partial θ} + \frac{\partial L}{\partial {y}_{1} \text{} *} \frac{\partial {y}_{1} \text{} *}{\partial θ} + \frac{\partial L}{\partial {y}_{2} \text{} *} \frac{\partial {y}_{2} \text{} *}{\partial θ} \qquad \text{[Math. 35]}$$

$$= \left(- {x}_{1} {e}^{i φ} sin θ + {x}_{2} {e}^{- i φ} cos θ\right) \frac{\partial L}{\partial {y}_{1}} - \left({x}_{1} {e}^{i φ} cos θ + {x}_{2} {e}^{- i φ} sin θ\right) \frac{\partial L}{\partial {y}_{2}}$$

$$\begin{matrix}+ \left(- {x}_{1} \text{} * {e}^{- i φ} sin θ + {x}_{2} \text{} * {e}^{i φ} cos θ\right) \frac{\partial L}{\partial {y}_{1} \text{} *} - \\ \left({x}_{1} \text{} * {e}^{- i φ} cos θ +\right) \left({x}_{2} \text{} * {e}^{i φ} sin θ\right) \frac{\partial L}{\partial {y}_{2} \text{} *}\end{matrix}$$

$$\begin{matrix}= {y}_{2} \frac{\partial L}{\partial {y}_{1}} - {y}_{1} \frac{\partial L}{\partial {y}_{2}} + {y}_{2} \text{} * \frac{\partial L}{\partial {y}_{1} \text{} *} - {y}_{1} \text{} * \frac{\partial L}{\partial {y}_{2} \text{} *} = \left({y}_{2} \frac{\partial L}{\partial {y}_{1}} + {y}_{2} \text{} * \frac{\partial L}{\partial {y}_{1} \text{} *}\right) - \\ \left({y}_{1} \frac{\partial L}{\partial {y}_{2}} + {y}_{1} \text{} * \frac{\partial L}{\partial {y}_{2} \text{} *}\right)\end{matrix}$$

$$\begin{matrix}= \left(Re \left({y}_{2}\right) \frac{\partial L}{\partial Re \left({y}_{1}\right)} + Im \left({y}_{2}\right) \frac{\partial L}{\partial Im \left({y}_{1}\right)}\right) - \\ \left(Re \left({y}_{1}\right) \frac{\partial L}{\partial Re \left({y}_{2}\right)} -\right) \left(Im \left({y}_{1}\right) \frac{\partial L}{\partial Im \left({y}_{2}\right)}\right)\end{matrix}$$

$$= 2 ⋅ Re \left({y}_{2} \text{} * \frac{\partial L}{\partial {y}_{1} \text{} *} - {y}_{1} \text{} * \frac{\partial L}{\partial {y}_{2} \text{} *}\right)$$

The present invention is not limited to the specifically disclosed embodiments described above and various modifications, changes, and combinations with existing techniques can be made without departing from the scope of the claims.

Reference Signs List

| | |
|---|---|
| 10 | learning apparatus |
| 101 | input apparatus |
| 102 | display apparatus |
| 103 | external I/F |
| 103 a | recording medium |
| 104 | communication I/F |
| 105 | processor |
| 106 | memory apparatus |
| 107 | bus |
| 201 | formulating unit |
| 202 | learning unit |
| 203 | storage unit |

1. A learning apparatus that learns a neural network including a linear transformation layer achieved by a weight matrix with a complex number as an element, the learning apparatus comprising:
a processor; and
a memory storing program instructions that cause the processor to:
formulate a differential equation of a loss function with respect to each of conjugate variables corresponding to input variables of the linear transformation layer and a differential equation of the loss function with respect to each of parameters of the neural network; and
learn the parameters of the neural network by backpropagation using the formulated differential equations.

2. The learning apparatus according to claim 1, wherein the linear transformation layer is achieved by a weight matrix represented by a product of matrices including at least one rotation matrix.

3. The learning apparatus according to claim 1, wherein the linear transformation layer is achieved by a weight matrix represented by a product of matrices including at least one complex Givens rotation matrix.

4. The learning apparatus according to claim 1, wherein the linear transformation layer is achieved by a weight matrix represented by a Fang-type matrix or a matrix that decomposes a Fang-type matrix into a form of a matrix product.

5. The learning apparatus according to claim 1, wherein
the program instructions cause the processor to:
create a computational graph by using the formulated differential equations, and
learn the parameters of the neural network by calculating values of the differential equations by forward propagation calculation and backpropagation calculation using the computational graph.

6. A learning method in which a computer that learns a neural network including a linear transformation layer achieved by a weight matrix with a complex number as an element executes:
formulating a differential equation of a loss function with respect to each of conjugate variables corresponding to input variables of the linear transformation layer and a differential equation of the loss function with respect to each of parameters of the neural network; and
learning the parameters of the neural network by backpropagation using the formulated differential equations.

7. A non-transitory computer-readable recording medium having stored therein a program causing a computer to perform the learning method according to claim 6.
